(19) United States
(12) Patent Application Publication
(10) Pub. No.: US 2013/0025250 A1
(43) Pub. Date: Jan. 31, 2013

(54) FRONT MOUNT ROTARY CUTTER WITH DISCHARGE CHUTES

(71) Applicants: Pierre HAMEL, Watkinsville, GA (US); Yannick CHAMPAGNE, Thetford Mines (CA); Louis LAMONTAGNE, Thetford Mines (CA)

(72) Inventors: Pierre HAMEL, Watkinsville, GA (US); Yannick CHAMPAGNE, Thetford Mines (CA); Louis LAMONTAGNE, Thetford Mines (CA)

(21) Appl. No.: 13/555,599

(22) Filed: Jul. 23, 2012

Related U.S. Application Data
(60) Provisional application No. 61/510,320, filed on Jul. 21, 2011.

(51) Int. Cl. A01D 34/66

(52) U.S. Cl. 56/255

(57) ABSTRACT

The present relates to a front mount rotary cutter. The present front mount rotary cutter comprises a shell, a drive coupler affixed to the shell, and a plurality of rotary blades hingedly mounted to the shell. The plurality of rotary blades is driven by the drive coupler. The present front mount rotary cutter also comprises a plurality of discharge chutes. The plurality of discharge chutes protects a vehicle and/or the drive coupler from dust and debris generated upon operation of the plurality of rotary blades.

### TECHNICAL FIELD

The present relates to a front mount rotary cutter, and more particularly to a front mount rotary cutter with discharge chutes.

### BACKGROUND

A mowing equipment may be mounted at the front or at the rear of a tractor. Specific advantages may be provided for the operation of the mowing equipment, associated to its position at the front or at the rear of the tractor respectively. Further, the design of the mowing equipment and/or of the tractor may condition the position (at the front or at the rear) of the mowing equipment. For instance, a drive coupler may be used to transfer drive power from the tractor to the mowing equipment. If the drive coupler is positioned at the front of the tractor, then the mowing equipment is mounted at the front of the tractor.

A specific type of mowing equipment consists in a mowing equipment with a rotary cutter. A detailed description of a rotary cutter will be given later in the description. One characteristic of a rotary cutter is to have one or several rotary blades. The rotation of the blades is performed via a drive coupler. The materials in contact with the rotary blades (essentially the cut debris) are projected in directions determined by the rotation of the blade(s).

One drawback of mowing equipment with a front mount rotary cutter is that debris are generated in front of the tractor. Thus some of the debris are projected in the direction of the tractor, and some of the debris are projected in the direction of the drive coupler. Thus, it would be desirable to have a mechanism to control the direction of ejection of the debris. There is therefore a need for a front mount rotary cutter with discharge chutes.

### SUMMARY

According to a first aspect, the present provides a front mount rotary cutter. The front mount rotary cutter comprises a shell, a drive coupler affixed to the shell, a plurality of rotary blades hingedly mounted to the shell, and a plurality of discharge chutes. The plurality of rotary blades is driven by the drive coupler.

According to a second aspect, the present provides a front mount rotary cutter, where each discharge chute is affixed on a rear section of the shell.

According to a third aspect, the present provides a front mount rotary cutter, where the plurality of discharge chutes is affixed to the shell adjacent to the drive coupler.

According to a fourth aspect, the present provides a front mount rotary cutter, where the plurality of discharge chutes comprises two discharge chutes. Further, the two discharge chutes are affixed on a rear section of the shell. And each discharge chute is affixed to a different side of the rear section of the shell.

According to a fifth aspect, the present provides a front mount rotary cutter, where the plurality of discharge chutes directs dust and debris generated during operation of the plurality of rotary blades away from the vehicle and/or the drive coupler.

According to a sixth aspect, the present provides a front mount rotary cutter, where the plurality of discharge chutes protects the vehicle and/or the drive coupler from dust and debris generated upon operation of the plurality of rotary blades.

The foregoing and other features of the present front mount rotary cutter with discharge chutes will become more apparent upon reading of the following non-restrictive description of examples of implementation thereof, given by way of illustration only with reference to the accompanying drawings.

### BRIEF DESCRIPTION OF THE DRAWINGS

In the appended drawings:

FIG. 1 is an underneath view of an exemplary embodiment of the present front mount rotary cutter;

FIG. 2 is a top view of an exemplary embodiment of the present front mount rotary cutter;

FIG. 3 is a top perspective view of an exemplary embodiment of the present front mount rotary cutter, installed on a tractor;

FIG. 4 is a perspective view of the exemplary embodiment of the front mount rotary cutter of FIG. 3, installed on a tractor; and

FIG. 5 is a rear perspective view of the exemplary embodiment of the front mount rotary cutter of FIG. 3, installed on a tractor.

### DETAILED DESCRIPTION

To better understand the present specification, the following definitions are provided:

Rotary cutter: One or several hingedly rotary blades attached to a drive in such a manner that when one blade hits a rock or stump, the blade bounces backwardly and inwardly, and inertia makes it continue outwardly. The rotary blades may be sharpened or not. In a specific aspect, the rotary blades are dull so they whack through dense plant growth, where a sharp blade gets stuck or slowed down. The rotary blades may be very heavy, up to an inch thick, so a momentum pulling out created by its rotation is stronger than a resistance offered by vegetation. The rotary blades may be made of heat treated high carbon steel that can withstand strikes with hard objects such as rocks and stones.

Front mount: Equipment to be mounted in front of a vehicle, such as for example a tractor.

Shell: structure for receiving the rotary cutters and a drive coupler.

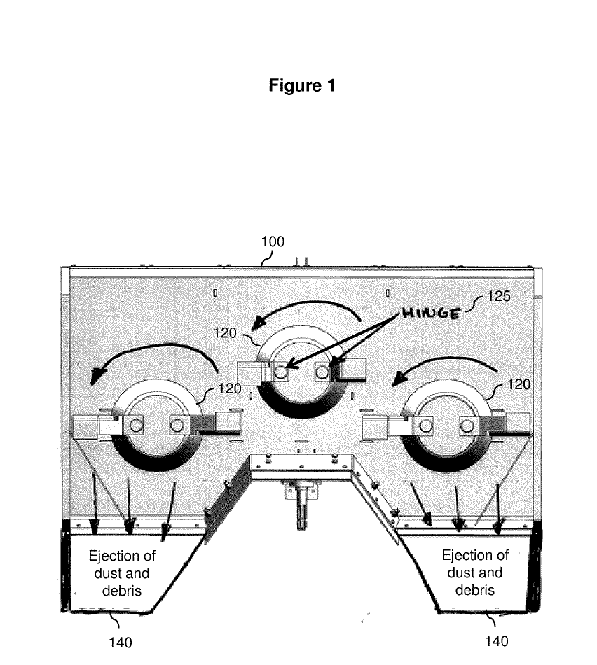

Reference is now made concurrently to FIGS. 1-5. The present relates to a front mount rotary cutter. The front mount rotary cutter comprises a shell, a drive coupler affixed to the shell, and a plurality of rotary blades. The rotary blades are hingedly mounted to the shell, and are driven by the drive coupler. The front mount rotary cutter also comprises a plurality of discharge chutes.

In a particular aspect, two discharge chutes are affixed to the shell, and more particularly project from a rear section of the shell.

Referring now specifically to FIG. 1, an underneath view of the front mount rotary cutter is represented. The front mount rotary cutter comprises the shell 100, three rotary blades 120, and two discharge chutes 140 affixed to the shell 100. Dust and debris generated during operation of the plurality of rotary blades 120 are ejected by the discharge chutes 140.

FIG. 1 represents three rotary blades 120. However, the number of rotary blades 120, as well as the position of the rotary blades 120 with respect to the shell 100, may be different without changing the scope of the presently disclosed front mount rotary cutter. In an exemplary embodiment represented in FIG. 1, each rotary blade 120 is hingedly mounted to the shell 100, by means of two hinges 125.

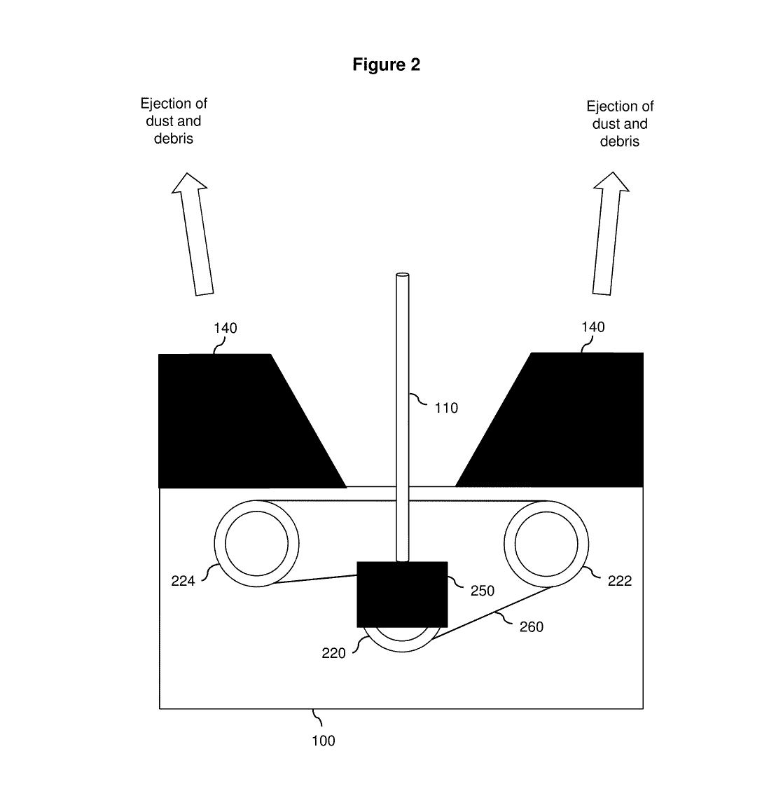

Referring now specifically to FIG. 2, a top view of the front mount rotary cutter of FIG. 1 is represented. The front mount rotary cutter comprises the shell 100 and the two discharge chutes 140 represented in FIG. 1.

The front mount rotary cutter further comprises a driver coupler 110 affixed to the shell 100. The drive coupler 110 transmits drive power from a vehicle, such as a tractor (not represented in FIG. 2), to the front mount rotary cutter. The rotary blades 120 of FIG. 1 are driven by the drive coupler 110 of FIG. 2.

In an exemplary embodiment represented in FIG. 2, an adaptor 250 transforms a rotational movement of the driver coupler 110 into a rotational movement of three rotating spindles 220, 222, and 224. For this purpose, the adaptor 250 directly transforms the rotational movement of the driver coupler 110 into a rotational movement of one of the rotating spindles 220. Then, a drive mechanism 260 (for example a drive belt as represented in FIG. 2) transmits the rotational movement of the rotating spindle 220 to the other rotating spindles 222 and 224.

Referring now concurrently to FIGS. 1 and 2, the rotational movement of each rotating spindle 220, 222, and 224 is further transmitted to one rotating blade 120. For instance, each rotating blade 120 may be attached to one of the rotating spindles (220, 222, or 224) by means a vertical rotating axis (not represented in FIGS. 1 and 2). The vertical rotating axis transmits the rotating movement of a rotating wheel (220, 222, or 224) to the rotating blade 120. The present fount mount rotary cutter may further comprise a casing for covering the rotating spindles 220,222 and 224 and the drive mechanism 260 from dust and debris generated during operation of the rotary blades.

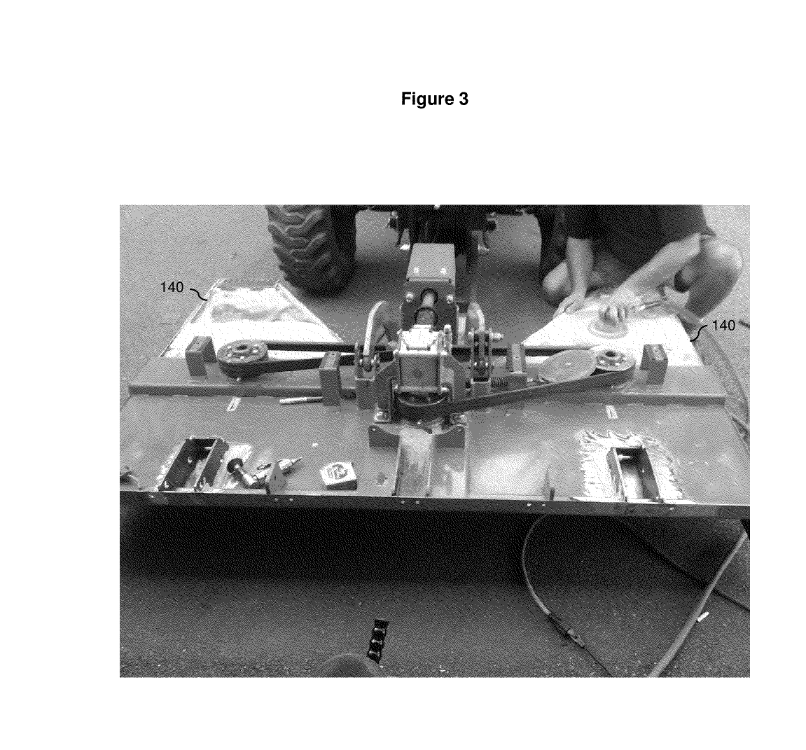

In another aspect, the plurality of discharge chutes is affixed to the shell adjacent to the drive coupler. As shown in FIGS. 2 and 3, two discharge chutes 140 are affixed to a rear section of the shell 100, on each side of the drive coupler 110, in a V- configuration adjacent to the drive coupler 110.

In another particular aspect, the plurality of discharge chutes comprises two discharge chutes, each of the two discharge chutes is affixed to a rear section of the shell, and each discharge chute is affixed to a different side of the rear section of the shell.

The plurality of discharge chutes directs dust and debris generated during operation of the plurality of rotary blades away from the drive coupler and/or the vehicle. The plurality of discharge chutes also protects the drive coupler and/or the vehicle from dust and debris generated upon operation of the plurality of rotary blades. FIG. 2 illustrates the protection of the drive coupler 110 by the discharge chutes 140 from the ejection of dust and debris.

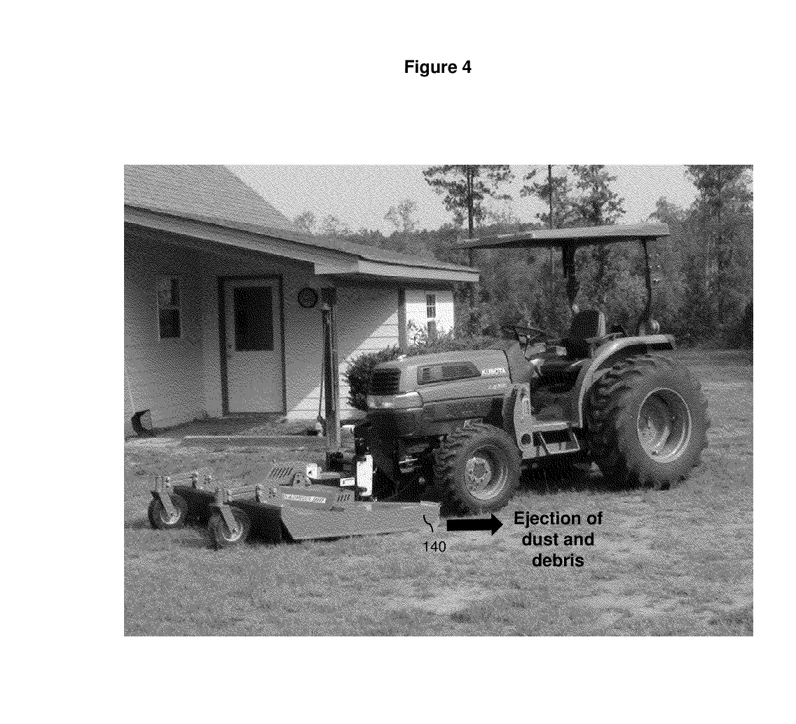

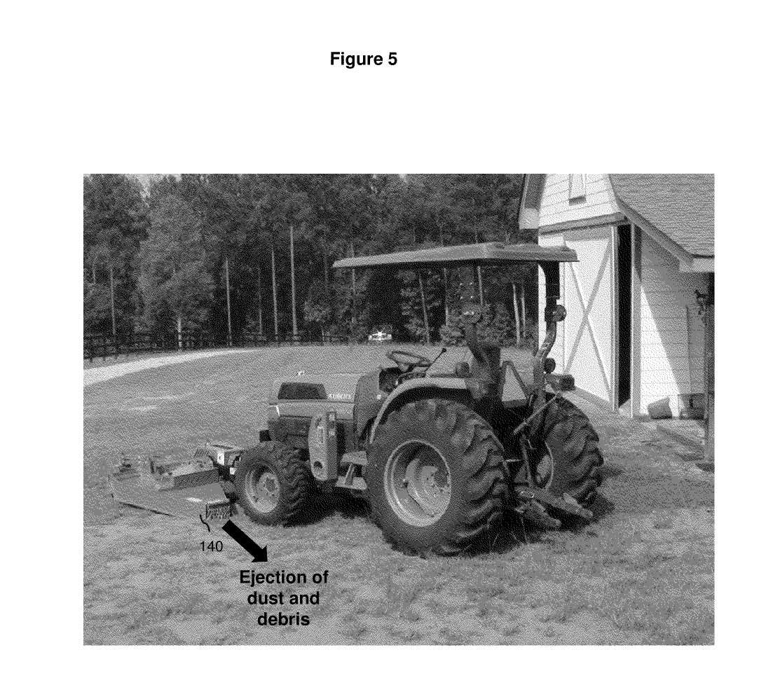

The present front mount rotary cutter has many advantages over prior art front mount rotary cutter. First, it directs ejection of dust and debris behind the vehicle onto which the front mount rotary cutter is mounted. Such an important improvement prevents obstruction of components of the vehicle (such as for example a radiator, an air inlet) by the dust and debris generated during operation of the rotary blades. Another advantage of the present front mount rotary cutter is to prevent exposure of an operator of the vehicle to dust and debris generated during operation of the rotary blades. Another important advantage of the discharge chutes in the present front mount rotary cutter is the evacuation of cut material and debris so as to reduce recirculation of debris and improve energetic efficiency of the vehicle onto which the front mount rotary cutter is installed. FIGS. 4 and 5 illustrate the protection of a vehicle (for example a tractor) by the discharge chutes 140 from the ejection of dust and debris.

Although the present front mount rotary cutter has been described in the foregoing description by way of illustrative embodiments thereof, these embodiments can be modified at will, within the scope of the appended claims without departing from the spirit and nature of the appended claims.

What is claimed is:

1. A front mount rotary cutter comprising:
a shell;
a drive coupler affixed to the shell;
a plurality of rotary blades hingedly mounted to the shell, the plurality of rotary blades being driven by the drive coupler; and
a plurality of discharge chutes.

2. The front mount rotary cutter of claim 1, wherein each discharge chute is affixed on a rear section of the shell.

3. The front rotary cutter of claim 1, wherein the plurality of discharge chutes is affixed to the shell adjacent to the drive coupler.

4. The front mount rotary cutter of claim 1, wherein the plurality of discharge chutes comprises two discharge chutes, the two discharge chutes are affixed on a rear section of the shell, and each discharge chute being affixed to a different side of the rear section of the shell.

5. The front mount rotary cutter of claim 1, wherein the plurality of discharge chutes directs dust and debris generated during operation of the plurality of rotary blades away from the vehicle.

6. The front mount rotary cutter of claim 1, wherein the plurality of discharge chutes directs dust and debris generated during operation of the plurality of rotary blades away from the drive coupler.

7. The front mount rotary cutter of claim 1, wherein the plurality of discharge chutes protects the vehicle from dust and debris generated upon operation of the plurality of rotary blades.

8. The front mount rotary cutter of claim 1, wherein the plurality of discharge chutes protects the drive coupler from dust and debris generated upon operation of the plurality of rotary blades.
